(19) United States
(12) Patent Application Publication
(10) Pub. No.: US 2025/0219227 A1
(43) Pub. Date: Jul. 3, 2025

(54) A SYSTEM OF FASTENING A BATTERY PACK

(71) Applicant: TVS MOTOR COMPANY LIMITED, Chennai (IN)

(72) Inventors: Rahim Faridi Shikh, Chennai (IN); M Pujar Mallamma, Chennai (IN)

(73) Assignee: TVS MOTOR COMPANY LIMITED, Chennai (IN)

(21) Appl. No.: 18/852,688

(22) PCT Filed: Jan. 17, 2023
(86) PCT No.: PCT/IN2023/050046

§ 371 Date: Sep. 30, 2024

(30) Foreign Application Priority Data
Mar. 30, 2022 (IN) 202241018613

(51) Int. Cl. H01M 50/262; B60L 50/64; B60L 53/16; B60L 53/80; H01M 10/46; H01M 10/48; H01M 10/613; H01M 10/6551; H01M 50/204; H01M 50/256; H02J 7/00

(52) U.S. Cl. CPC H01M 50/262; B60L 50/64; B60L 53/16; B60L 53/80; H01M 10/46; H01M 10/488; H01M 10/613; H01M 10/6551; H01M 50/204; H01M 50/256; H02J 7/0045

(57) ABSTRACT

A battery pack includes: a lever on a front portion of the battery pack; and a latching unit operably connected to the lever. The lever actuates engagement and disengagement of the battery pack with an enclosure. The latching unit is disposed at a rear portion of the battery pack and is configured to engage and disengage the battery pack from the enclosure.

### TECHNICAL FIELD

The present subject matter described herein generally relates to charge a battery for a vehicle. More specifically, the present disclosure relates to a battery pack lock mechanism being provided to be conveniently swapped by a user.

### BACKGROUND

Typically, electric vehicles are powered by battery electric power. Battery Electric Vehicles, also known as BEV's are more frequently called as EV's, are fully electric vehicles with rechargeable batteries and no gasoline engine. All energy to run the vehicle comes from the battery pack which is recharged from the grid. BEVs are zero emissions vehicles, as they do not generate any harmful tailpipe emissions or air pollution hazards caused by traditional gasoline-powered vehicles.

The most commonly known electrified vehicles are those that rely on off-board electrical power are Plug-In Hybrid Electric Vehicles (PHEV). Plug-in Hybrid Electric Vehicles, or PHEVs, have both an engine and electric motor to drive the car. Like regular hybrids, they can recharge their battery through regenerative braking. They differ from regular hybrids by having a much larger battery, and being able to plug into the grid to recharge.

Hybrid Electric Vehicles, or HEVs, have both a gas-powered engine and an electric motor to drive the car. All energy for the battery is gained through regenerative braking, which recoups otherwise lost energy in braking to assist the gasoline engine during acceleration.

Typically, utilization of used battery would keep hazardous materials from entering the waste stream, both at the end of a battery's useful life and during its production. Hence, it is need of the hour to develop a mechanism to utilize the used battery to minimize the life-cycle impacts of using lithium-ion and other kinds of batteries in vehicles.

### BRIEF DESCRIPTION OF DRAWINGS

The detailed description of the present subject matter is described with reference to the accompanying figures. Same reference signs are used throughout the drawings to reference like features and components.

FIGS. 1a, 1b, and 1c exemplarily illustrates a perspective view of a front side, a rear side and a top view of a battery pack respectively,

FIG. 2 exemplarily illustrates a perspective view of a battery pack,

FIGS. 3a, 3b and 3c exemplarily illustrates a perspective view of a battery charging unit,

FIGS. 4a and 4b exemplarily illustrates a perspective view of a battery charging unit and a battery pack in accordance with an embodiment of the present subject matter.

### DETAILED DESCRIPTION OF THE INVENTION

The existing market for Electric Vehicle batteries is currently dominated by expensive and highly combustible materials like lithium and cobalt. Continued dependence on these materials will have a deleterious impact on long-term market prospects. Accordingly, initiatives aimed at developing new, cost-competitive batteries with enhanced safety profiles is need of the hour.

Generally, when a rider or driver of the vehicle, has to travel long distances, he will face the limitation of mileage since the existing battery can travel within a range of 10-40 miles. For long distance travel, electric vehicles are still not a feasible solution. Hence, the rider or driver of the vehicle, after a few miles of travel, will have to get the battery recharged from a charging station. However, the wait period during travel increases for the rider. Hence, it is required to have improved range of the vehicle and reduce the range anxiety of the rider. Further, there should be an improved system of charging battery where one can avoid the vehicle to become idle or unusable till the time drained battery is getting charged.

The above-mentioned problem may be overcome by providing a swappable battery arrangement. Exchanging batteries of electric vehicles makes it possible to realize ‘Peak Load Shifting’ of power grid and helps in boosting equipment using efficiency and reducing maximum load of power grid as well. Furthermore, with convenient maintenance and longer lifespan of battery, replacing batteries is worthy of being popularized in such specific fields as public transit, car rental and logistics.

Many electric vehicles are designed to be powered by replacing batteries and locate the batteries at their chassis, separating batteries from drivers and passengers. Accordingly, larger available space, safer driving environment, lower gravity centre of the vehicle and enhanced vehicle operating performance can be ensured. Thus, the technology of installing and replacing batteries located on chassis is the trend in development of electric vehicles with swappable batteries.

Power battery is the only power source of an electric-only vehicle, which is usually swapped by automation equipment due to its heavy weight as well as backbreaking manual labour and risk of hand operation. The battery pack needs to be locked after installation. The more firmly it is installed, the safer it will be. Since it is necessary to unlock the battery pack when exchanging the battery, it will be better to more simply and quicker to install and detach it. Accordingly, the on-board security and reliability as well as the convenient exchanging of the battery pack depend on the performance of lock mechanism.

However, in the existing battery locking mechanism, the battery pack is pushed and pulled from within a battery charging unit, the connector pins get damaged. Further, mechanical engagement and disengagement with bare hands is not advisable and not feasible due to space constraints in pushing and pulling the battery pack within the battery charging unit. Furthermore, the constraints with existing battery charging unit is that there is a requirement for a latching mechanism along with the coupler to lock the pins at place between the male coupler and the female coupler. However, engagement and disengagement of this lock mechanism is also cumbersome in existing battery packs. Further lifting of the battery packs to swap requires effort from the vehicle or from the battery charging unit. Furthermore, the vehicle is prone to more vibrations due to frequent swapping of the batteries.

Further, existing swappable battery packs are flexibly fastened onto vehicles by locking devices and are more or less vibrated with respect to the vehicles during driving. This leads to many serious problems, such as local deformation of battery packs, deformation of suspension points on vehicle bodies, local wear of the locking devices as well as arc discharge and burning arc of electric connector, may be resulted in, severely endangering safe driving. Previously described problems can't be resolved by any existing swappable battery packs. Accordingly, there is a need for battery pack lock mechanism which is not only safe, reliable and easy to replace, but also be able to prevent loosening of the battery pack during long period of vehicle body vibration.

This invention relates a battery pack. The battery pack comprises a lever. The lever being configured on a front portion of the battery pack. The lever being configured to actuate an engagement and a disengagement of the battery pack with an enclosure.

As per an aspect of present invention, the battery pack comprises a latching unit, the latching unit being disposed at a rear portion of the battery pack, the latching unit being configured to engage and disengage the battery pack from the enclosure.

As per another aspect of present invention, the latching unit being actuated by the lever of the battery pack, the latching unit being configured to engage with a locking unit, the locking unit being provided in a first portion of the enclosure.

As per yet another aspect of present invention, the battery pack comprises a male coupler, the male coupler being capable of engaging with a female coupler of the enclosure. The enclosure being configured to function as one of a battery charging unit and a battery discharging unit. The engagement of said female coupler and male coupler enables a continuous power supply required to charge the battery pack through the battery charging unit and enables discharge of the battery pack through the battery discharging unit. The male coupler being provided on a rear portion of the battery pack.

As per another aspect of present invention, a plurality of fins are provided on at least one side portion of the battery pack to dissipate heat generated during one of a charging operation and discharging operation and to facilitate as guiding members for insertion and removal of the battery pack from the enclosure. The plurality of fins being configured to correspond to a plurality of guide members configured in the enclosure. As per an alternate embodiment, a plurality of guide rollers are disposed on a bottom portion of the battery pack to correspond to a plurality of guide members configured in the enclosure.

As per an aspect of present invention, the battery pack comprises a handle on a front portion and the handle being integrated with the lever for actuating engagement and disengagement of the battery pack from the enclosure. The lever being operably connected to the latching unit through a force transmission member. The force transmission member being concealed inside the battery pack.

As per another aspect of the present invention, a battery enclosing assembly is disclosed. The battery enclosing assembly comprises an enclosure and a battery pack. The battery pack discloses a latching unit. The latching unit being configured to engage with a locking unit. The locking unit being provided in an inner surface of a first portion of the enclosure.

As per another aspect of the present invention, the battery pack comprises a male coupler being capable of engaging with a female coupler of the enclosure, wherein the enclosure being configured to function as one of a battery charging unit and a battery discharging unit. The engagement of the male coupler and the female coupler enables a continuous power supply required to charge the battery pack through the battery charging unit and enables discharge of the battery pack through the battery discharging unit. The male coupler being provided on an external surface of a rear portion of the battery pack and the female coupler being provided on an inner surface of a first portion of the enclosure.

As per another aspect of the present invention, the enclosure comprising a power connector on an external surface of the first portion of the enclosure to connect the battery pack to a wiring harness of a powered device when the battery pack being disposed within the enclosure.

As per another aspect of the present invention, the battery pack comprising a handle on a front portion, the handle being integrated with the lever for actuating engagement and disengagement of the battery pack from the enclosure.

As per another aspect of the present invention, the enclosure comprising an opening, the enclosure being configured to receive the battery pack through the opening for accommodating the battery pack.

As per another aspect of the present invention, enclosure comprises a display unit to display a status of charge of the battery pack, when the battery pack being disposed within the enclosure.

The present invention provides a fastening means for the battery pack which enables it to be safely and reliably installed and to be conveniently swapped whenever required by a user. The battery pack is well protected from vibrations of the vehicle.

The details provided above explains the basic features of the invention and does not limit the scope of the invention. The nature and further characteristic features of the present subject matter will be made clearer from the following descriptions made with reference to the accompanying drawings.

Exemplary embodiments detailing features of an internal combustion engine, in accordance with the present subject matter will be described hereunder with reference to the accompanying drawings. Various aspects of different embodiments of the present subject matter will become discernible from the following description set out hereunder. Rather, the following description provides a convenient illustration for implementing exemplary embodiments of the present subject matter. Also, it is to be understood that the phraseology and terminology used herein is for the purpose of description and should not be regarded as limiting.

The present subject matter along with all the accompanying embodiments and their other advantages would be described in greater detail in conjunction with the figures in the following paragraphs.

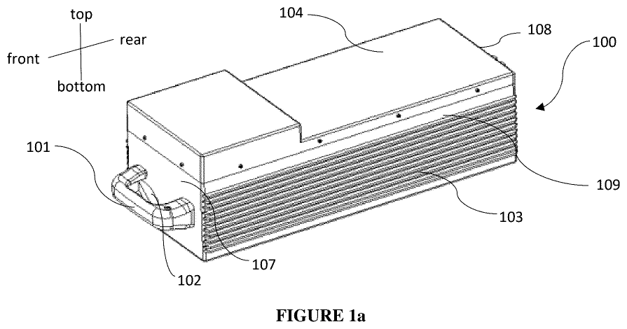

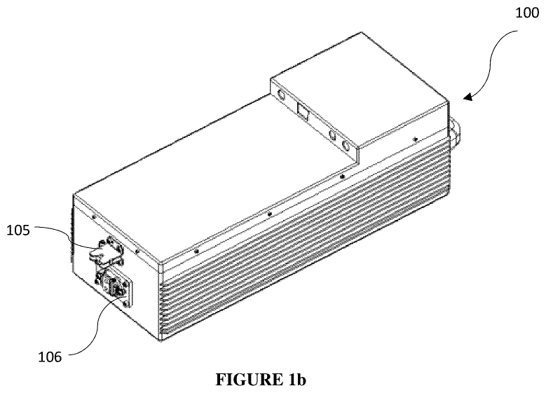

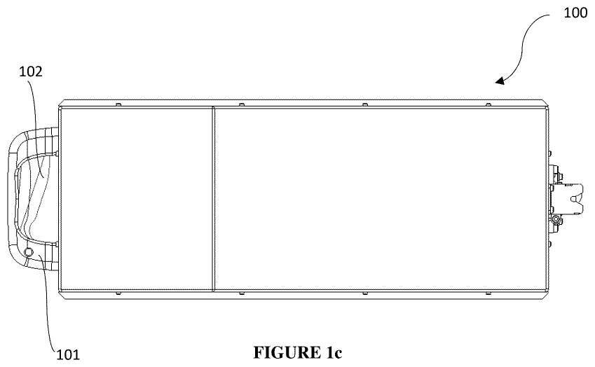

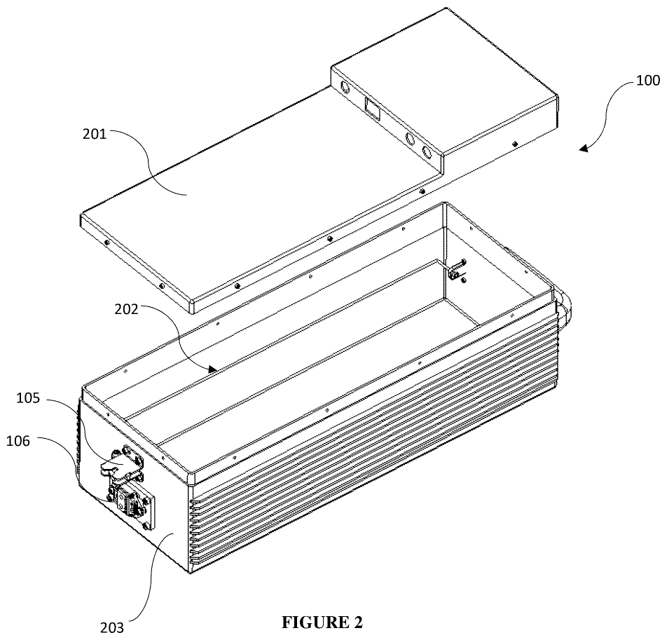

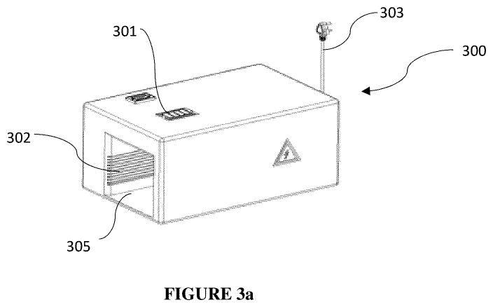

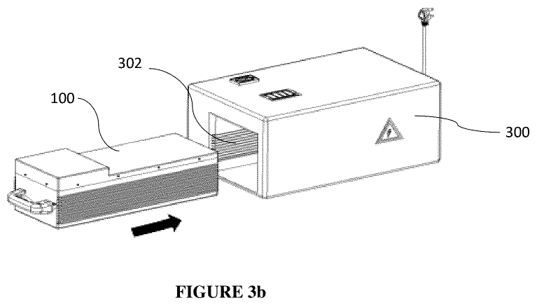

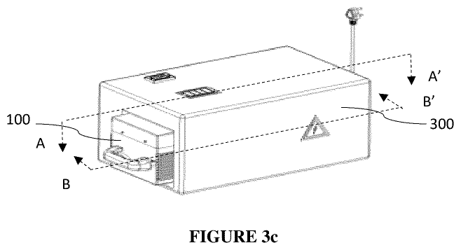

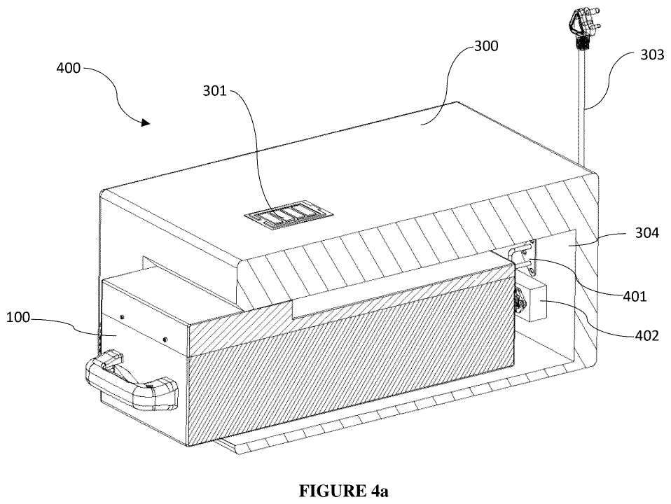

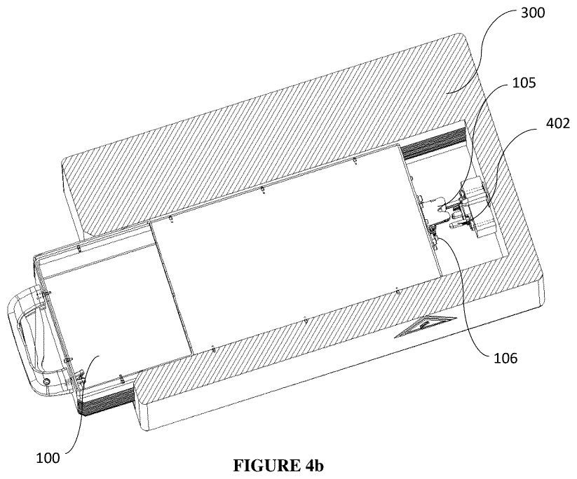

FIGS. 1a, 1b, and 1c exemplarily illustrate a perspective view of a front side, a rear side, and a top side of a battery pack 100, respectively. The battery pack 100 comprises an exterior portion 104, a plurality of fins 103, a handle 101, and a lever 102. The handle 101 is provided on a front portion 107 of the battery pack 100 so that the user can pull or push the battery pack 100 conveniently without causing any distortion, damage or deformity to the battery pack 100. Further, a lever 102 is provided to actuate fastening of the battery pack 100 with an enclosure 300 (shown in FIGS. 3a-3b). The enclosure 300 could be a box like structure into which the battery pack 100 is accommodated and the enclosure 300 may be disposed in any powered device, such a vehicle powered by the battery pack 100. The battery pack 100 comprises a latching unit 105 provided at a rear portion 108. The latching unit 105 is operably connected to the lever 102 and the latching unit 105is configured to engage and disengage the battery pack 100 from the enclosure 300. The latching unit 105 is actuated by the lever 102 of the battery pack 100 and the latching unit 105 is configured to engage with a locking unit 401 of the enclosure 300 (shown in FIGS. 4a-4b). In an embodiment, the handle 101 is integrated with the lever 102 for actuating engagement and disengagement of the battery pack 100 from the enclosure 300. Furthermore, the lever 102 is operably connected to the latching unit 105 through a force transmission member 202 (shown in FIG. 2), the force transmission member 202 being concealed inside the battery pack 100.

The plurality of fins 103 of the battery pack 100 helps in dissipation of the heat generated during the operation of the battery pack 100. The plurality of fins 103 provided on a side portion 109 of the battery pack 100 can also function as a guiding mechanism to slide the battery pack 100 inside the enclosure 300 and to remove the battery pack 100 from the enclosure 300. The plurality of fins 103 are configured to correspond to a plurality of guide members 302 (shown in FIGS. 3a-3b) configured in the enclosure 300. The enclosure 300 can either be a battery charging unit or a battery discharging unit or both.

In an embodiment, the battery pack 100 further comprises a male coupler 106 at the rear portion 108 for power transmission/reception. The male coupler 106 is provided below the latching unit 105 at the rear portion 108 of the battery pack 100. The male coupler 106 being capable of engaging with a female coupler 402 (shown in FIGS. 4a-4b) of the enclosure 300. The engagement of the female coupler 402 and male coupler 106 enables a continuous power supply required to charge the battery pack 100 through the enclosure 300, when the enclosure 300 is a battery charging unit. The engagement of the female coupler 402 and male coupler 106 enables discharge of the battery pack 100 through the enclosure 300, when the enclosure 300 is a battery discharging unit.

In an embodiment, a plurality of guide rollers or guide members in

form of grooves are configured on a bottom portion of the battery pack 100 to correspond to a plurality of guide members 302 configured in the enclosure 300.

FIG. 2 exemplarily illustrates an exploded view of a battery pack 100. In an embodiment, the battery pack 100 is configured to have a container 203 accommodating a plurality of battery cells and the container 203 is closed with a lid 201. The container 203 may be a cuboidal box formed with 5 walls and open at one end and the open end being closed by the lid 201. The force transmission member 202 is disposed inside the container 203 of the battery pack 100. The force transmission member 202 connects the lever 102 to the latching unit 105. The force transmission member 202 helps in actuating the latching unit 105. When a lever 102 is pulled, the force transmission member 202 is also pulled. The force transmission member 202 pulls a gate of the locking unit 105 which is used to lock the battery pack 100 with the enclosure 300. When force transmission member 202 is pulled, then the gate is also pulled thereby unlocking the battery pack 100 from the enclosure 300. Therefore, the lever 102 is used to actuate the engagement and disengagement of the battery pack 100 with the enclosure 300. The force transmission member 202 may be a cable connecting the lever 102 and the locking unit 105.

FIGS. 3a, 3b, and 3c exemplarily illustrate perspective view of the enclosure 300 with or without the battery pack 100 in it. The enclosure 300 has a display unit 301 to show a status of charge of the battery pack 100, when the battery pack 100 is disposed within the enclosure 300. A plurality of guide members 302 are provided inside the enclosure 300 to properly and easily place or remove the battery pack 100 within or from the enclosure 300. A power plug 303 is connected to the enclosure 300 to receive power supply, in the case, the enclosure 300 is a battery charging unit. In an embodiment, the enclosure 300 may be connected to a wiring harness of the powered device for discharging of the battery pack 100 to the electrical loads in the powered device through the enclosure 300, when the enclosure 300 is a battery discharging unit. The engagement of the male coupler 106 and the female coupler 402 enables a continuous power supply required to charge the battery pack 100 through the battery charging unit. The engagement of the male coupler 106 and the female coupler 402 enables discharge of the battery pack 100 through the battery discharging unit. In FIG. 3b, a user can push the battery pack 100 inside the enclosure 300. The male coupler 106 and the latching unit 105 of the battery pack 100 are connected to the female coupler 402 and a locking unit 401 of enclosure 300 respectively. In an embodiment, position of the male coupler and the female coupler may be interchanged. That is, the male coupler may be provided in the inner surface of the first portion 304 of the enclosure 300 and the female coupler may be provided in the rear portion 108 of the battery pack 100. The locking unit 401 is provided in an inner surface of a first portion 304 (shown in FIGS. 4a-4b) of the enclosure 300. In an embodiment, the enclosure 300 comprising a power connector on an external surface of the first portion 304 of the enclosure 300 to connect the battery pack 100 to the wiring harness of a powered device when the battery pack 100 being disposed within the enclosure 300. The powered device can be a vehicle. The enclosure 300 can be one of a utility space, a battery charging unit or a battery discharging unit. The enclosure 300 may or may not be provided in a vehicle. In an embodiment, the enclosure 300 may only be a mechanical housing accommodating the battery pack in the powered device with no electrical connections. The enclosure 300 is configured to receive a battery pack 100 through an opening 305 for accommodating the battery pack 100.

FIG. 4a exemplarily illustrates a sectional view of an a battery

enclosing assembly 400 having the enclosure 300 with the battery pack 100 within, taken along A-A′ in FIG. 3c. FIG. 4b exemplarily illustrates a sectional view of the battery enclosing assembly 400 having the enclosure 300 with the battery pack 100 within, taken along B-B′ in FIG. 3c. The battery pack 100 comprises the male coupler 106 being capable of engaging with the female coupler 402 of the enclosure 300. The engagement of the male coupler 106 and the female coupler 402 enables a continuous power supply required to charge the battery pack 100 through the battery charging unit and enables discharge of the battery pack 100 through the battery discharging unit.

The latching mechanism and the couplers when provided in any application such a vehicle aid in engagement and disengagement of the battery pack from the vehicle, without physical effort from the user to lift the battery pack and position the battery pack. The battery charging unit may be in the vehicle for on-board charging of the battery pack or external to it available at the charging stations. The electrical connections of the batteries within the container extend till male coupler of the battery pack. Guide members inside the enclosure may receive rollers of the battery pack for easy sliding of the battery pack from/into the enclosure.

Furthermore, the present invention is applicable for a vehicle where the enclosure being fitted to a vehicle and the enclosure is acting either as a battery charging unit or battery discharging unit or both. This allows the vehicle to be available for the user round the clock without waiting for the battery pack to get charged, the users just have to swap the discharged battery pack and put it inside the enclosure which is functioning as a battery charging unit and use the already charged battery pack. This also allows the vehicle equipped for long trips without any wait period in between for charging. This is a cost-effective method with environmental benefits as the battery pack once purchased by a user is reusable. Also, actuation of the latching mechanism, that is engagement between the lever, the latching unit, and the locking unit is very simple and easy to be performed by the user of the powered device. The simpler latching mechanism also allows for easy removal and insertion of the battery pack from within the enclosure. Also, heat dissipation of the battery pack is also taken care by eth fins of the battery pack that are in contact with the enclosure and the heat transmitted to the enclosure may be dissipated by any known heat transfer mechanisms.

Many modifications and variations of the present subject matter are possible in the light of above disclosure. Therefore, within the scope of claims of the present subject matter, the present disclosure may be practiced other than as specifically described.

### LIST OF REFERENCE NUMERALS

100: Battery Pack
101: Handle
102: Lever
103: Fins
104: Exterior portion
105: Latching unit
106: Connector on a battery pack
107: A front portion of a battery pack
108: A rear portion of a battery pack
109: A side portion of a battery pack
201: Lid of a battery pack
202: A force transmission member
203: Container
300: Enclosure
301: Display
302: Guides on enclosure
303: Power supply
304: First portion of the enclosure
305: Opening of the enclosure
401: Locking unit
402: Female coupler on enclosure

1.-22. (canceled)

23. A battery pack, comprising:
a lever on a front portion of the battery pack; and
a latching unit operably connected to the lever, wherein
the lever actuates engagement and disengagement of the battery pack with an enclosure, and
the latching unit is disposed at a rear portion of the battery pack and is configured to engage and disengage the battery pack from the enclosure.

24. The battery pack according to claim 23, wherein
the latching unit is actuated by the lever of the battery pack and is configured to engage with a locking unit, and
the locking unit is disposed in an inner surface of a portion of the enclosure.

25. The battery pack according to claim 23, further comprising:
a male coupler that is capable of engaging with a female coupler of the enclosure, wherein
the enclosure functions as either of a battery charging unit or a battery discharging unit, and
engagement of the female coupler with the male coupler enables a continuous power supply required to charge the battery pack through the battery charging unit or enables discharge of the battery pack through the battery discharging unit.

26. The battery pack according to claim 25, wherein the male coupler is disposed on the rear portion of the battery pack.

27. The battery pack according to claim 23, further comprising fins on at least one side portion of the battery pack and that dissipate heat generated during either of a charging operation or a discharging operation and facilitate as guiding members for insertion and removal of the battery pack from the enclosure.

28. The battery pack according to claim 27, wherein the fins correspond to guide members on an inner surface of the enclosure.

29. The battery pack according to claim 28, further comprising guide rollers on a bottom portion of the battery pack and that correspond to the guide members of the enclosure.

30. The battery pack according to claim 23, further comprising a handle on the front portion of the battery pack and that is integrated with the lever and actuates engagement and disengagement of the battery pack from the enclosure.

31. The battery pack according to claim 23, wherein the lever is operably connected to the latching unit through a force transmission member that is concealed inside the battery pack.

32. A battery enclosing assembly, comprising:
an enclosure; and
a battery pack accommodated in the enclosure, wherein
the battery pack comprising:
a latching unit; and
a lever, wherein
the latching unit is operably connected to the lever, and
the latching unit is configured to engage and disengage the battery pack from the enclosure,
the lever of the battery pack is disposed on a front portion of the battery pack,
the latching unit is disposed at a rear portion of the battery pack, and
the latching unit is actuated by the lever of the battery pack for engagement and disengagement of the battery pack from the enclosure.

33. The battery enclosing assembly according to claim 32, wherein the lever is operably connected to the latching unit through a force transmission member that is concealed inside said battery pack.

34. The battery enclosing assembly according to claim 32, wherein the latching unit is configured to engage with a locking unit that is disposed in an inner surface of a portion of the enclosure.

35. The battery enclosing assembly according to claim 32, wherein
the enclosure comprises guide members on an inner surface of the enclosure, and
the guide members correspond to at least either of fins or guide rollers of the battery pack.

36. The battery enclosing assembly according to claim 35, wherein the fins are disposed on at least one side portion of the battery pack, dissipate heat generated during either of a charging operation or a discharging operation, and facilitate as a guiding member for insertion and removal of the battery pack from the enclosure.

37. The battery enclosing assembly according to claim 32, wherein
the battery pack comprises a male coupler that is capable of engaging with a female coupler of the enclosure,
the enclosure functions as either of a battery charging unit or a battery discharging unit, and
engagement of the male coupler with the female coupler enables a continuous power supply required to charge the battery pack through the battery charging unit or enables discharge of the battery pack through the battery discharging unit.

38. The battery enclosing assembly according to claim 37, wherein
the male coupler is disposed on an external surface of a rear portion of the battery pack, and
the female coupler is disposed on an inner surface of a portion of the enclosure.

39. The battery enclosing assembly according to claim 38, wherein the enclosure comprises a power connector on an external surface of the portion of the enclosure and that connects the battery pack to a wiring harness of a powered device.

40. The battery enclosing assembly according to claim 32, wherein the battery pack further comprises a handle on the front portion of the battery pack and that is integrated with the lever and actuates engagement and disengagement of the battery pack from the enclosure.

41. The battery enclosing assembly according to claim 32, wherein the enclosure has an opening and is configured to receive the battery pack through the opening for accommodating the battery pack.

42. The battery enclosing assembly according to claim 32, wherein the enclosure comprises a display unit that displays a status of charge of the battery pack.
